(19) United States
(12) Patent Application Publication
(10) Pub. No.: US 2006/0245089 A1
(43) Pub. Date: Nov. 2, 2006

(54) Optical module

(75) Inventor: Chun-Yu Lee, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/377,844

(22) Filed: Mar. 16, 2006

(30) Foreign Application Priority Data
Apr. 29, 2005 (CN) 200510034511.6

(51) Int. Cl. G02B 7/02

(52) U.S. Cl. 359/826

(57) ABSTRACT

An optical module (100) includes a barrel (12), a sleeve (14), and a lens module (16). The lens module is secured in the sleeve. The sleeve is made of a low coefficient of thermal expansion material and is secured in the barrel. When temperature changes, the relative location of the lens module and the barrel changes little.

### BACKGROUND OF THE INVENTION

1. Field if the Invention

The present invention generally relates to optical modules used in photography and imaging equipment and, more particularly, to an optical module for a digital camera.

2. Discussion of the related Art

Currently, digital camera modules are included as a feature in a wide variety of portable electronic devices and, of course, in stand-alone digital camera units. Most portable electronic devices are becoming progressively more miniaturized over time, and digital camera modules are correspondingly becoming smaller and smaller. Nevertheless, in spite of the small size of a contemporary digital camera module, consumers still demand excellent imaging.

Optical modules used for digital camera modules typically each include a barrel and a lens module. The barrel and the lens module directly contact with each other, and the lens module is fixedly mounted in the barrel. In some systems, the barrel and the lens module are made of plastic material. When ambient temperature changes, the barrel and the lens module deform greatly (i.e., expand or shrink) due to high thermal expansion coefficient in plastic materials, which leads to a change in the relative location of the lens module and the barrel. Therefore, imaging quality of the optical module can be poor at extreme temperatures.

Therefore, what is needed is an optical module which is less subject to ambient temperature and therefore can work in a wider range of temperatures.

### SUMMARY OF THE INVENTION

An optical module includes a barrel, a sleeve and a lens module. The lens module is secured in the sleeve. The sleeve is made of a low thermal expansion coefficient material and is secured in the barrel.

Other advantages and novel features will become more apparent from the following detailed description when taken in conjunction with the accompanying drawings.

### BRIEF DESCRIPTION OF THE DRAWINGS

Many aspects of the optical module can be better understood with reference to the following drawings. The components in the drawings are not necessarily to scale, the emphasis instead being placed upon clearly illustrating the principles of the present optical module. Moreover, in the drawings, like reference numerals designate corresponding parts throughout the several views.

FIG. 1 is a schematic view of an optical module in accordance with a first embodiment of the present invention; and

FIG. 2 is a schematic view of an optical module in accordance with a second embodiment of the present invention.

### DETAILED DESCRIPTION OF THE EMBODIMENTS

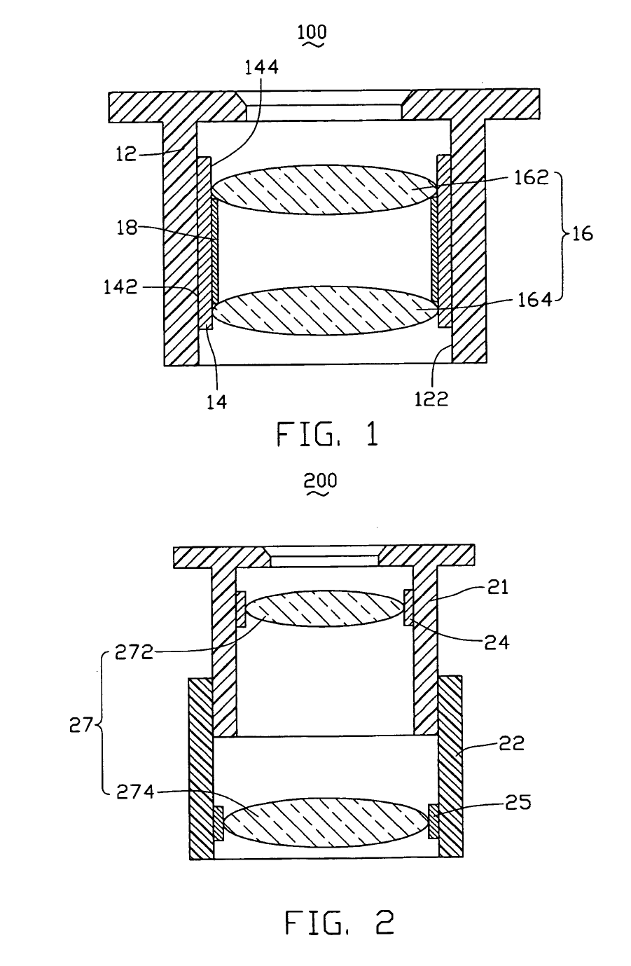

Referring to FIG. 1, an optical module 100 according to a first embodiment of the present invention includes a barrel 12, a sleeve 14, and a lens module 16.

The barrel 12 is substantially a hollow cylinder, which is made of plastic material. The barrel 12 has an inner barrel surface 122.

The sleeve 14 is also substantially a hollow cylinder, which is made of a material with a low coefficient of thermal expansion, for example, ceramic or optical glass. The coefficient of thermal expansion of the material of the sleeve 14 is lower than that of plastic material of the barrel 12. In the illustrated embodiment, the coefficient of linear expansion of the material of the sleeve 14 is in a range 10⁻⁶˜10⁻⁹ (1/k). The sleeve 14 has an outer sleeve surface 142 and an inner sleeve surface 144. The sleeve 14 is secured in the barrel 12 by using, for example, a glue/adhesive or a press fit, with the outer sleeve surface 142 of the sleeve 14 being adhered to the inner barrel surface 122 of the barrel 12. The sleeve 14 and the barrel 12 are coaxial.

The lens module 16 includes at least one lens, which is made of plastic material. In the illustrated embodiment, the lens module 16 includes a first lens 162 and a second lens 164. The first lens 162 and the second lens 164 are fixedly mounted within the sleeve 14, and the lens module 16 and the sleeve 14 are coaxial. In order to fasten the first and second lenses 162, 164 with each other, an annular partition 18 is secured between the first lens 162 and the second lens 164 by using, for example, a glue/adhesive or a press fit. The partition 18 is adhered to the inner sleeve surface 144 of the sleeve 14.

In the first embodiment of the optical module 100, the lens module 16 is separated from the barrel 12 by the sleeve 14. The sleeve 14 is made of a material with a low coefficient of thermal expansion, and has little deformation due to temperature. Therefore, even if the barrel 12 and the lens module 16 are deformed when ambient temperature changes, the deformed barrel 12 and the deformed lens module 16 do not affect each other. Thus, the relative location of the barrel 12 and the lens module 16 changes little with ambient temperature variations, and the optical module 100 can produce images with consistent quality in a greater range of temperatures. In further alternative embodiments, the sleeve 14 can be replaced by other separation elements which can separates the lens module 16 from the barrel 12, for example, a plurality of arc-shaped pieces or any other suitable shape.

Referring to FIG. 2, an optical module 200 according to a second embodiment of the present invention is shown. The optical module 200 includes a first barrel 21, a second barrel 22, a first sleeve 24, a second sleeve 25, and a lens module 27. The first barrel 21, the second barrel 22 and the lens module 27 are all made of plastic material. The first sleeve 24 and the second sleeve 25 are both made of a material with a low coefficient of thermal expansion, for example, ceramic or optical glass. The first barrel 21 is slidably disposed in the second barrel 22. The first sleeve 24 and the second sleeve 25 are secured in the first barrel 21 and the second barrel 22, respectively. In the illustrated embodiment, the lens module 27 includes a first lens 272 and a second lens 274. The first lens 272 and the second lens 274 are fixedly mounted within the first sleeve 24 and the second sleeve 25, respectively. The lens module 27, the barrels 21, 22 and the sleeves 24, 25 are all coaxial. In use, the first barrel 21 can slide in the second barrel 22 to alter the focal length of the optical module 200.

The first lens 272 is separated from the first barrel 21 by the first sleeve 24. The second lens 274 is separated from the second barrel 22 by the second sleeve 25. When temperature changes, the first sleeve 24 and the second sleeve 25 have little deformation. Thus, the first sleeve 24 and the second sleeve 25 can assure that the relative location of the lens module 27 and the barrel 21, 22 changes little.

In the above-described embodiments, the barrel 12, the first barrel 21 and the second barrel 22 are all made of plastic material. In alternative embodiments, the barrel 12, the first barrel 21 and the second barrel 22 can be made of other materials, for example, metal material.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical module, comprising:
a first barrel;
a first sleeve made of a material with a low coefficient of thermal expansion, the first sleeve secured in the first barrel; and
a lens module secured in the first sleeve.

2. The optical module as claimed in claim 1, wherein the first barrel is substantially a hollow cylinder, and is made of plastic material.

3. The optical module as claimed in claim 2, wherein the coefficient of thermal expansion of the material of the first sleeve is lower than that of plastic material of the first barrel.

4. The optical module as claimed in claim 3, wherein the coefficient of linear expansion of the material of the first sleeve is in a range 10⁻⁶˜10⁻⁹ (1/k).

5. The optical module as claimed in claim 3, wherein the first sleeve is substantially a hollow cylinder, and is made of one of ceramic material and optical glass material.

6. The optical module as claimed in claim 1, wherein the lens module comprises two lenses, and is made of plastic material.

7. The optical module as claimed in claim 6, wherein an annular partition is secured between the lenses.

8. The optical module as claimed in claim 6, further comprising a second barrel, wherein the first barrel is slidably disposed in the second barrel.

9. The optical module as claimed in claim 8, further comprising a second sleeve, wherein the sleeves are secured in the barrels, respectively, and the lenses are secured in the sleeves, respectively.

10. An optical module, comprising:
a first barrel made of plastic material;
a first sleeve secured in the first barrel, wherein a coefficient of thermal expansion of a material of the first sleeve is lower than that of plastic material of the first barrel; and
a lens module made of plastic material, the lens module secured in the first sleeve.

11. The optical module as claimed in claim 10, wherein the coefficient of linear expansion of the material of the first sleeve is in a range 10⁻⁶˜10⁻⁹ (1/k).

12. The optical module as claimed in claim 10, wherein the first sleeve is substantially a hollow cylinder, and is made of one of ceramic material and optical glass material.

13. The optical module as claimed in claims 10, wherein the lens module comprises two lenses, and an annular partition is secured between the lenses.

14. The optical module as claimed in claim 13, further comprising a second barrel, wherein the first barrel is slidably disposed in the second barrel.

15. The optical module as claimed in claim 14, further comprising a second sleeve, wherein the sleeves are secured in the barrels, respectively, and the lenses are secured in the sleeves, respectively.

16. An optical module, comprising:
a barrel;
a lens module located in the barrel; and
a separation element engaged between the barrel and the lens module to separate the barrel from the lens module.

17. The optical module as claimed in claim 16, wherein the separation element is a sleeve.

18. The optical module as claimed in claim 16, wherein the separation element is a plurality of arc-shaped pieces.

19. The optical module as claimed in claim 16, wherein a coefficient of thermal expansion of a material of the separation element is lower than that of a material of either one of the lens module and the barrel.
